(19) United States
(12) Patent Application Publication
(10) Pub. No.: US 2024/0345526 A1
(43) Pub. Date: Oct. 17, 2024

(54) IMAGE FORMING APPARATUS THAT DETECTS SETTING FAILURE OF SHEETS IN PAPER TRAY BASED ON OUTPUT SIGNAL OF IMAGE SENSOR

(71) Applicant: KYOCERA Document Solutions Inc., Osaka (JP)

(72) Inventor: Kohei ISHIDO, Osaka (JP)

(73) Assignee: KYOCERA Document Solutions Inc., Osaka (JP)

(21) Appl. No.: 18/635,104

(22) Filed: Apr. 15, 2024

(30) Foreign Application Priority Data
Apr. 17, 2023 (JP) 2023-067353

(51) Int. Cl. G03G 15/00

(52) U.S. Cl. CPC G03G 15/607; G03G 15/5016; G03G 15/6558; G03G 2215/00379; G03G 2215/00679

(57) ABSTRACT

An image forming apparatus includes a paper tray, a pair of conveyance rollers, an image sensor, and a control apparatus. A large number of sheets are stacked and set in the paper tray. The pair of conveyance rollers convey the sheets to a transfer position of an image. The image sensor reads the sheets upstream of the transfer position. The control apparatus processes an output signal from the image sensor. The control apparatus calculates an amount of lateral displacement of the sheet from an output signal when the image sensor reads the sheet, and detects a setting failure of the sheet in the paper tray when the control apparatus continuously calculates an amount of lateral displacement exceeding a predetermined threshold value.

### INCORPORATION BY REFERENCE

This application claims priority to Japanese Patent Application No. 2023-067353 filed on 17 Apr. 2023, the entire contents of which are incorporated by reference herein.

### BACKGROUND

The present disclosure relates to an image forming apparatus.

In general, an image forming apparatus in which a resist unit is installed in the middle of a sheet conveyance path is known. The resist unit is provided with a pair of resist rollers with a conveyance path interposed therebetween and is also provided with an image sensor to detect skew or lateral displacement of a sheet. The resist unit is installed on an upstream side of a transfer position, and the pair of resist rollers wait for a sheet in front of the transfer position and correct the skew or lateral displacement of the sheet. Then, the sheet is sent out from the pair of resist rollers toward the transfer position in synchronization with an image forming operation.

### SUMMARY

As one aspect of the present disclosure, a technique that is further improved from the above technique is proposed.

An image forming apparatus according to one aspect of the present disclosure includes a paper tray, a pair of conveyance rollers, an image sensor, and a control apparatus. A large number of sheets are set in a stack on the paper tray. The pair of conveyance rollers convey the sheets to a transfer position of an image. The image sensor reads the sheets upstream of the transfer position. The control apparatus includes a processor and processes an output signal from the image sensor by executing a computer program by the processor. The control apparatus calculates an amount of lateral displacement of the sheets from an output signal when the image sensor reads the sheets, and detects a setting failure of the sheets in the paper tray when the control apparatus continuously calculates an amount of lateral displacement exceeding a predetermined threshold value.

### BRIEF DESCRIPTION OF THE DRAWINGS

FIG. 1 is a schematic diagram of a printer according to the present embodiment.

FIG. 2 is a schematic diagram of a resist unit and a control apparatus of the present embodiment.

FIG. 3 is a schematic diagram of a control configuration of an image sensor according to the present embodiment.

FIG. 4 is a timing chart of a case in which a sheet edge is detected in the present embodiment.

FIG. 5 is a flowchart showing processing for detecting a setting failure of a sheet according to the present embodiment.

### DETAILED DESCRIPTION

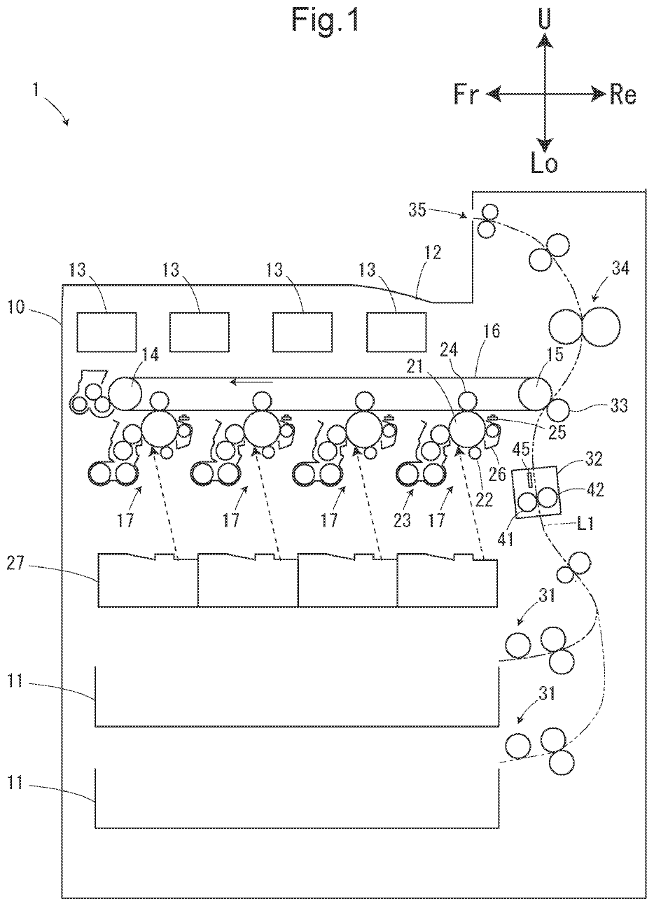

Hereinafter, an embodiment of the present disclosure will be described with reference to the drawings. In the following description, a printer will be exemplified as an image forming apparatus. FIG. 1 is a schematic diagram of the printer according to the present embodiment. Arrows Fr, Re, U, and Lo indicate a front side, a rear side, an upper side, and a lower side of the printer, respectively.

As shown in FIG. 1, a printer 1 includes a box-shaped housing 10 in which various devices are accommodated. A plurality of paper feed cassettes (paper trays) 11 on which a large number of sheets are set in a stack are provided at a lower part of the housing 10, and a paper discharge tray 12 on which sheets that have undergone image formation are stacked is provided at an upper part of the housing 10. Toner containers 13 accommodating toners are removably set below the paper discharge tray 12 to correspond to respective toner colors (for example, four colors of magenta, cyan, yellow, and black). An intermediate transfer belt 16 is provided below the plurality of toner containers 13 to be stretched over a pair of rollers 14 and 15.

A plurality of image forming units 17 are lined up below the intermediate transfer belt 16 in a conveyance direction of the intermediate transfer belt 16. The image forming units 17 are rotatably provided with a photoreceptor drum 21 in rolling contact with the intermediate transfer belt 16. Around each of the photoreceptor drums 21, a charger 22, a developer 23, a primary transfer roller 24, a static eliminator 25, and a cleaning apparatus 26 are installed in the order of a primary transfer process. A waste toner box is connected to the cleaning apparatus 26. An exposure unit 27 constituted by a laser scanning unit (LSU) is provided below each of the image forming units 17.

A conveyance path L1 of a sheet from the paper feed cassette 11 to the paper discharge tray 12 is formed by a plurality of rollers at a side inside the housing 10. A paper feeder 31 is provided on an upstream side (lower side) of the conveyance path L1, and a resist unit 32 is provided on a downstream side of the paper feeder 31 on the conveyance path L1. A secondary transfer roller 33 is provided at a side end of the intermediate transfer belt 16 on a downstream side of the resist unit 32 on the conveyance path L1, and a fixing apparatus 34 is provided on a downstream side of the secondary transfer roller 33 on the conveyance path L1. A paper discharge port 35 is provided at a downstream end (upper side) of the conveyance path L1.

During image formation of the printer 1, the surface of the photoreceptor drum 21 is charged by the charger 22, and then an electrostatic latent image is formed on the surface of the photoreceptor drum 21 by laser light from the exposure unit 27. Next, a toner is attached to the electrostatic latent image on the surface of the photoreceptor drum 21 from the developer 23 to form a toner image, and the toner image is primarily transferred from the surface of the photoreceptor drum 21 to the surface of the intermediate transfer belt 16. Toner images of the respective colors are primarily transferred onto the intermediate transfer belt 16 in the respective image forming units 17, and thus a full-color toner image is formed on the surface of the intermediate transfer belt 16. Charges remaining on the photoreceptor drum 21 are removed by the static eliminator 25. Waste toner remaining on the photoreceptor drum 21 is removed by the cleaning apparatus 26.

On the other hand, a sheet is taken in from the paper feed cassette 11 by the paper feeder 31, and the sheet is sent out from the resist unit 32 toward the secondary transfer roller 33. A full-color toner image is secondarily transferred from the surface of the intermediate transfer belt 16 to the surface of the sheet by the secondary transfer roller 33, and the transferred sheet is conveyed toward the fixing apparatus 34 downstream of the secondary transfer roller 33. The toner image is fixed onto the sheet in the fixing apparatus 34, and the fixed sheet is discharged from the paper discharge port 35 onto the paper discharge tray 12. In this manner, the toner image transferred to the sheet passes through the fixing apparatus 34, thereby forming an image on the surface of the sheet.

Incidentally, the resist unit 32 is provided with an image sensor 45 for detecting lateral displacement of a sheet, in addition to a pair of resist rollers (conveyance rollers) 41 and 42. The resist unit 32 corrects the lateral displacement of the sheet detected by the image sensor 45, but there is a limit to the amount of lateral displacement that can be corrected by the resist unit 32. When the sheet is not correctly set in the paper feed cassette 11, lateral displacement that cannot be corrected by the resist unit 32 will occur, causing jams or defective images. In the printer 1 according to the present embodiment, a sheet setting failure in the paper feed cassette 11 is detected using a reading function of the image sensor 45.

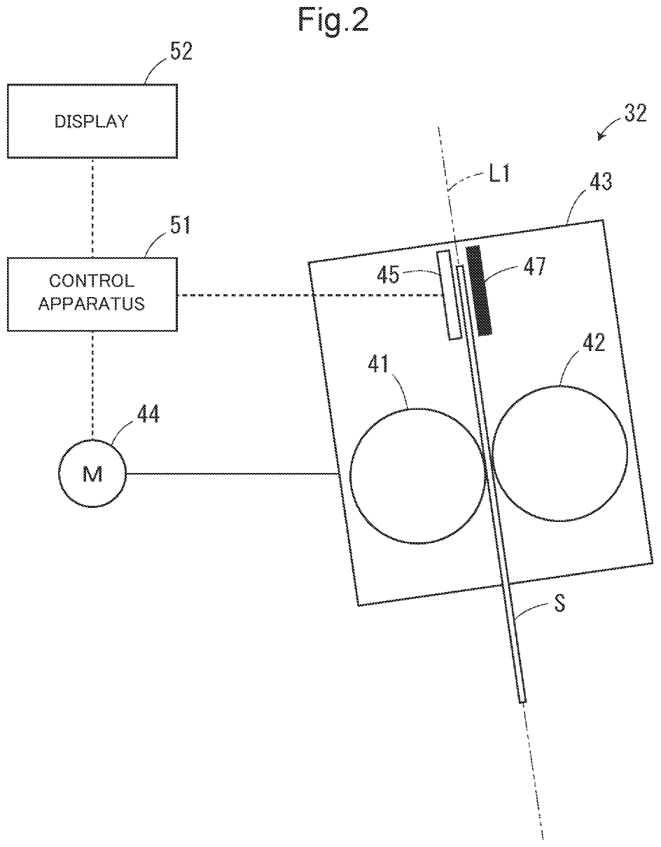

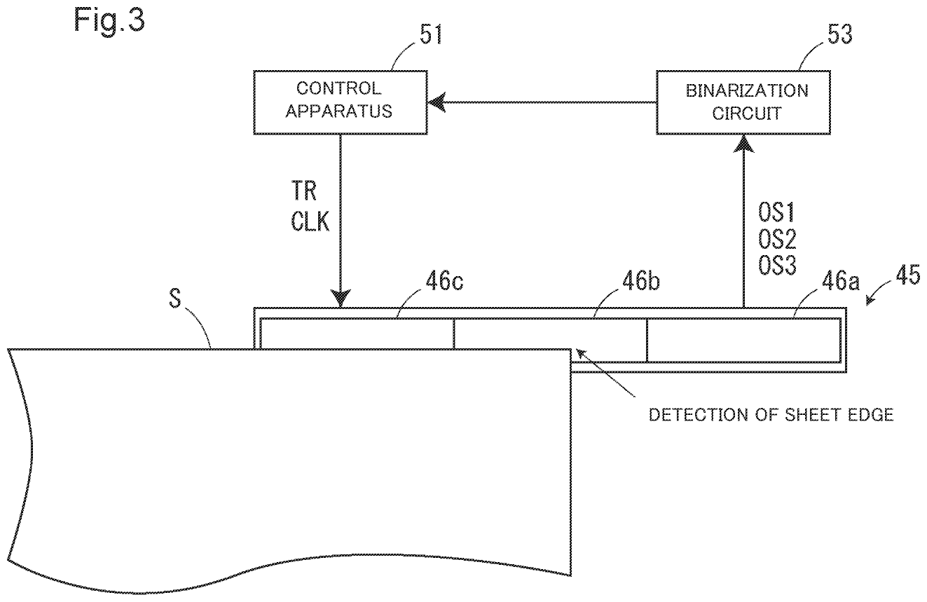

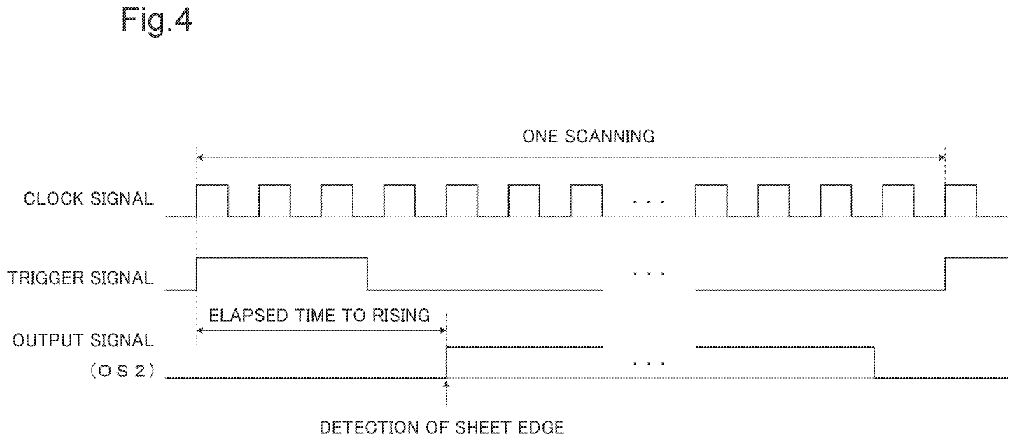

A function of correcting a detection position of the image sensor installed in the printer will be described with reference to FIGS. 2 to 4. FIG. 2 is a schematic diagram of the resist unit and a control apparatus according to the present embodiment. FIG. 3 is a schematic diagram of a control configuration of the image sensor according to the present embodiment. FIG. 4 is a timing chart of a case in which a sheet edge is detected in the present embodiment.

As shown in FIG. 2, the pair of resist rollers 41 and 42 are installed in the resist unit 32 with the conveyance path L1 of a sheet S interposed therebetween. Skew of the sheet S is corrected by a leading edge of the sheet S hitting the pair of resist rollers 41 and 42, and lateral displacement of the sheet S is corrected by moving a unit case 43 that supports the pair of resist rollers 41 and 42 in the lateral direction. The skew of the sheet S is corrected in front of a secondary transfer position (transfer position) of the secondary transfer roller 33 (see FIG. 1) by the pair of resist rollers 41 and 42, and the sheet S is conveyed from the pair of resist rollers 41 and 42 to the secondary transfer position while the lateral displacement of the sheet S is corrected by the unit case 43.

The image sensor 45 and a black background member 47 are installed downstream of the pair of resist rollers 41 and 42 and upstream of the secondary transfer position with the conveyance path L1 interposed therebetween. As the image sensor 45, a contact image sensor (CIS) is used. The background member 47 is irradiated with detection light from the image sensor 45, and the detection light is absorbed by a black surface of the background member 47 when the sheet S is not being conveyed. When the sheet S enters between the image sensor 45 and the background member 47, the detection light is reflected by a white surface of the sheet S, and the reflected light is received by the image sensor 45, whereby the sheet S is read.

An output signal from the image sensor 45 is processed by the control apparatus 51. The control apparatus 51 detects the coordinates of the sheet edge from the output signal of the image sensor 45, and calculates the amount of lateral displacement of the sheet S from a difference between the detected coordinates of the sheet edge and the reference coordinates of the sheet edge. The reference coordinates of the sheet edge are set to the detected coordinates in a state where lateral displacement of the sheet S does not occur. A correction motor 44 is connected to the control apparatus 51. When the amount of lateral displacement of the sheet S is calculated by the control apparatus 51, the unit case 43 is moved by the correction motor 44, and the lateral displacement of the sheet S is corrected.

Furthermore, the control apparatus 51 compares a predetermined threshold value with the amount of lateral displacement of the sheet S. A limit value of the amount of lateral displacement that can be corrected by the resist unit 32 is set as the predetermined threshold value. When the control apparatus 51 calculates the amount of lateral displacement equal to or less than the predetermined threshold value, correction processing is performed on the sheet S because the amount of lateral displacement can be corrected by the resist unit 32. When the control apparatus 51 calculates the amount of lateral displacement exceeding the predetermined threshold value, the resist unit 32 cannot correct the amount of lateral displacement, and thus correction processing for the sheet S is stopped. When lateral displacement that cannot be corrected occurs in the sheet S, the resist unit 32 does not forcibly correct the lateral displacement of the sheet S.

When the control apparatus 51 continuously calculates the amount of lateral displacement exceeding the predetermined threshold value, a setting failure of the sheet S in the paper feed cassette 11 (see FIG. 1) is detected. In this case, the number of times of calculation of the amount of excessive lateral displacement exceeding the predetermined threshold value is counted, and when the number of times of calculation of the amount of excessive lateral displacement is equal to or more than a predetermined number of times of calculation, it is determined that the sheet S is incorrectly set in the paper feed cassette 11. When a setting failure of the sheet S is detected, a conveyance operation of the sheet S is stopped by the control apparatus 51. For the predetermined threshold value and the predetermined number of times of calculation, values that are obtained experimentally, empirically, or theoretically in advance are used.

A display (notification apparatus) 52 that displays (notifies) various information regarding an image forming operation for the sheet S is connected to the control apparatus 51. When a setting failure of the sheet S is detected, a notification signal is output from the control apparatus 51 to the display 52. Based on the notification signal from the control apparatus 51, a message (information) for prompting a user to check the paper feed cassette 11 is displayed on the display 52. This message allows an operator to check the paper feed cassette 11 of the sheet S and re-set the sheet S in the paper feed cassette 11 when incorrect setting of the sheet in the paper feed cassette 11 occurs, an incorrect sheet size is set, or the like.

The control apparatus 51 may be realized by software using a processor, or may be realized by a logic circuit (hardware) formed in an integrated circuit or the like. When the processor is used, various processes are performed by the processor reading and executing programs stored in a memory. As the processor, for example, a central processing unit (CPU) is used. The memory is constituted by one or a plurality of storage devices such as a read only memory (ROM) and a random access memory (RAM) depending on purposes.

As shown in FIG. 3, the image sensor 45 is installed to be biased to the sheet S in the width direction. A detection surface of the image sensor 45 is divided into first to third detection blocks 46a, 46b, and 46c, and a large number of photoelectric conversion elements are arranged in a line in a main scanning direction for each of the first to third detection blocks 46a, 46b, and 46c. A trigger signal and a clock signal are input to the image sensor 45 from the control apparatus 51. Reading is started in the first to third detection blocks 46a, 46b, and 46c in response to the trigger signal, and signals are output to a binarization circuit 53 from the elements of the first to third detection blocks 46a, 46b, and 46c one by one in response to the clock signal.

In this case, in the first to third detection blocks 46a, 46b, and 46c, detection light from a light source is reflected by the sheet S, and the reflected light from the sheet S is received by the large number of photoelectric conversion elements. Analog signals are output to the binarization circuit 53 from the large number of photoelectric conversion elements of the first to third detection blocks 46a, 46b, and 46c. Then, the analog signals are converted into digital signals by the binarization circuit 53 and outputted to the control apparatus 51 as output signals from the image sensor 45. In this manner, the image sensor 45 reads the sheet S, and the output signals are output from the image sensor 45 to the control apparatus 51 via the binarization circuit 53.

As shown in FIG. 4, one scanning is an operation from the input of a trigger signal to the input of the next trigger signal, and an output signal is output in accordance with a clock signal. When lateral displacement of the sheet S is detected, an output signal of the detection block 46 through which a sheet edge passes is used. For example, in the case of an A4-size sheet S, an output signal (OS2) of the second detection block 46b is used. In this case, the control apparatus 51 detects the coordinates of the sheet edge from the number of clocks between a rising edge of the trigger signal and a rising edge of the output signal. Then, the amount of lateral displacement is determined from a difference between the detected coordinates of the sheet edge and reference coordinates of a sheet edge of the A4-size sheet.

Every time the control apparatus 51 obtains the amount of lateral displacement of the sheet S, the amount of lateral displacement of the sheet S is compared with a predetermined threshold value. In the conveyance path L1 of the printer 1, the amounts of lateral displacement of ±2 [mm] or more are rare, and when such lateral displacement occurs frequently, there is a high likelihood that the sheet S is incorrectly set in the paper feed cassette 11. For this reason, 2 [mm] is set in the control apparatus 51 as a predetermined threshold value. When the amount of lateral displacement exceeding 2 [mm] is continuously obtained, a setting failure of the sheet S is detected, and the display 52 notifies the user of the detection of the setting failure. In order to suppress frequent notifications, a predetermined threshold value may be set to 4 [mm] with a margin.

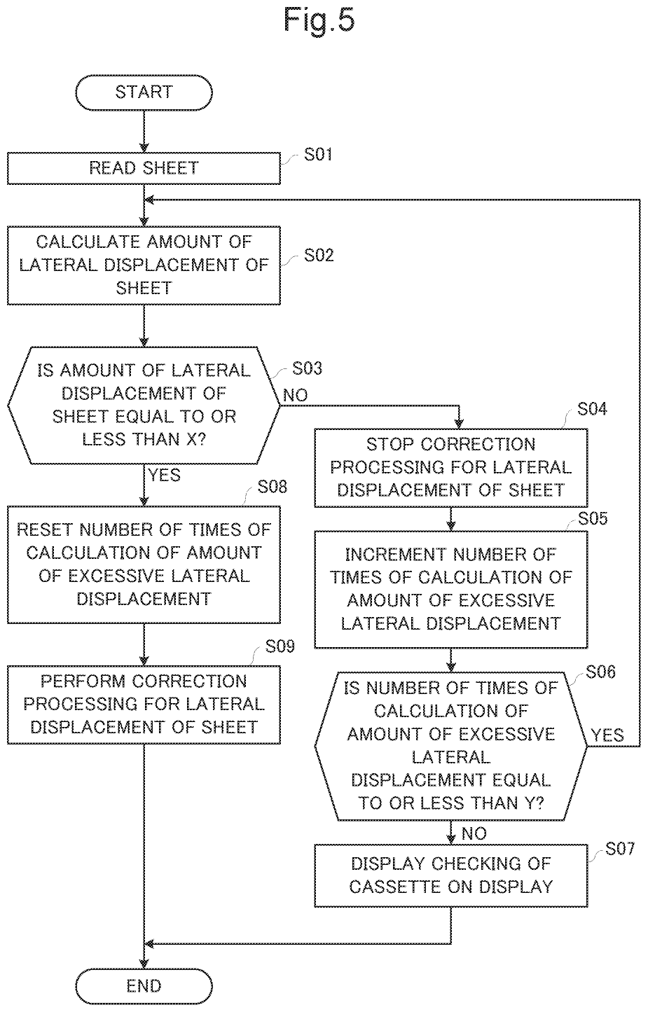

Processing for detecting a setting failure of a sheet will be described with reference to FIG. 5. FIG. 5 is a flowchart showing the processing for detecting a setting failure of a sheet according to the present embodiment. Here, description will be made using the signs in FIG. 2 as appropriate. Further, the following flowchart is merely an example and can be modified as appropriate.

As shown in FIG. 5, the image sensor 45 reads the sheet S during sheet conveyance (step S01), and the control apparatus 51 calculates the amount of lateral displacement of the sheet S (step S02). In this case, when a trigger signal is output from the control apparatus 51 to the image sensor 45, a timer is clocked, and an output signal is output from the image sensor 45 to the control apparatus 51. The control apparatus 51 detects the coordinates of a sheet edge based on an elapsed time from a rising edge of the trigger signal to a rising edge of the output signal, and calculates the amount of lateral displacement from a difference between the detected coordinates of the sheet edge and the reference coordinates of the sheet edge.

When the amount of lateral displacement of the sheet S exceeds a predetermined threshold value X (No in step S03), correction processing for the sheet S is stopped (step S04), and the number of times of calculation of the amount of excessive lateral displacement is incremented (step S05). When the number of times of calculation of the amount of excessive lateral displacement is equal to or less than a predetermined number of times of calculation Y (Yes in step S06), the processing proceeds to step S02. When the number of times of calculation of the amount of excessive lateral displacement is greater than the predetermined number of times of calculation Y (No in step S06), the control apparatus 51 detects a setting failure of the sheet S, and a message for prompting the user to check the paper feed cassette 11 is displayed on the display 52 (step S07).

On the other hand, when the amount of lateral displacement of the sheet S is equal to or less than the predetermined threshold value X (Yes in step S03), the control apparatus 51 resets the number of times of calculation of excessive lateral displacement (step S08). Thereby, when the amount of excessive lateral displacement is not calculated continuously, the number of times of calculation is returned to “0”. Then, the correction motor 44 is controlled by the control apparatus 51 while the sheet is being conveyed, and the lateral displacement of the sheet S is corrected (step S09). In this case, the correction motor 44 is driven based on the amount of lateral displacement of the sheet S, and the unit case 43 is moved laterally by the correction motor 44, whereby the lateral displacement of the sheet S is corrected. Incidentally, in the above-described general image forming apparatus, when a sheet is not set correctly in a paper tray or a sheet size is incorrect, there is a concern that lateral displacement may not be corrected, and there is a concern that jams or defective images may occur.

On the other hand, according to the present embodiment, a setting failure of the sheet S in the paper feed cassette 11 is detected using the image sensor 45 for correcting lateral displacement and skew of the sheet S. When excessive lateral displacement that cannot be corrected occurs in the sheet S due to incorrect setting of the sheet S in the paper feed cassette 11 or an incorrect sheet size, image forming processing is stopped, making it possible to prevent jams or defective images from occurring.

In the present embodiment, the image sensor is installed downstream of the resist roller, but the image sensor may be installed upstream of the resist roller. In this case, the amount of skew of a sheet may be calculated by detecting the coordinates of a sheet front edge from an output signal of the image sensor. For example, the amount of skew is calculated from a difference in timing when the sheet front edge passes through two locations on the right and left sides of the image sensor.

Further, in the present embodiment, a CIS is exemplified as an image sensor, but other image sensors such as a charge couple device (CCD) sensor may be used as an image sensor.

Furthermore, in the present embodiment, the pair of resist rollers are exemplified as a pair of conveyance rollers that convey a sheet to an image transfer position, but a pair of resistless rollers may be used as a pair of conveyance rollers. That is, the image forming apparatus may be provided with a resistless unit instead of the resist unit.

Furthermore, in the present embodiment, the image forming apparatus corrects lateral displacement of a sheet, but the image forming apparatus may correct lateral displacement and/or skew of a sheet.

Furthermore, in the present embodiment, the display is exemplified as a notification apparatus, but the notification apparatus is not limited to the display. The notification apparatus may be any device that gives a notification of information on an image forming operation for a sheet. For example, the information on the image forming operation for the sheet may be notified of using a sound, or the information on the image forming operation for the sheet may be notified of using a beep sound.

Further, in the present embodiment, the control apparatus of the apparatus main body may process an output signal from the image sensor, or a control apparatus of the resist unit, which is separate from the control apparatus of the apparatus main body, may process the output signal from the image sensor.

Further, in the present embodiment, the paper feed cassette is exemplified as a paper tray, but the paper tray is not limited to the paper feed cassette. The paper tray may be one in which a large number of sheets are stacked and set, or may be a manual feed tray, for example.

Furthermore, in the present embodiment, the printer is exemplified as an image forming apparatus, but the image forming apparatus is not limited to the printer. In addition to a copy machine and a facsimile machine, the image forming apparatus may be a multifunction device having multiple functions such as a print function, a copy function, and a facsimile function.

Although the present embodiment has been described, other embodiments may be adopted by combining the above-described embodiments and modifications in whole or in part.

The technique of the present disclosure is not limited to the above-described embodiments, and may be variously changed, replaced, and modified without departing from the spirit of the technical idea. Furthermore, when the technical idea can be realized in a different manner by the advance of a technique or other derived techniques, the disclosure may be implemented using the method. Thus, the claims cover all embodiments that may fall within the scope of the technical spirit.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An image forming apparatus comprising:
a paper tray on which a large number of sheets are set in a stack;
a pair of conveyance rollers that convey the sheets to a transfer position of an image;
an image sensor that reads the sheets upstream of the transfer position; and
a control apparatus that includes a processor and processes an output signal from the image sensor by executing a computer program by the processor,
wherein the control apparatus calculates an amount of lateral displacement of the sheets from an output signal when the image sensor reads the sheets, and detects a setting failure of the sheets in the paper tray when the control apparatus continuously calculates an amount of lateral displacement exceeding a predetermined threshold value.

2. The image forming apparatus according to claim 1, wherein the control apparatus performs correction processing on the sheets when an amount of lateral displacement equal to or less than the predetermined threshold value is calculated, and stops the correction processing on the sheets when an amount of lateral displacement exceeding the predetermined threshold value is calculated.

3. The image forming apparatus according to claim 1, further comprising:
a notification apparatus that gives a notification of information on an image forming operation for the sheets,
wherein, when a setting failure of the sheets is detected, the notification apparatus gives a notification of information for promoting checking of the paper tray.

4. The image forming apparatus according to claim 1, further comprising:
a unit case that supports the pair of conveyance rollers,
wherein the control apparatus performs correction processing for the sheets by moving the unit case in a lateral direction.
